(19) United States
(12) Patent Application Publication
(10) Pub. No.: US 2014/0137415 A1
(43) Pub. Date: May 22, 2014

(54) ACCESSORY FOR A RECIPROCATING SAW

(71) Applicant: TECHTRONIC POWER TOOLS TECHNOLOGY LIMITED, Tortola (VG)

(72) Inventor: Christopher Clearman, Anderson, SC (US)

(73) Assignee: Techtronic Power Tools Technology Limited, Tortola (VG)

(21) Appl. No.: 13/681,550

(22) Filed: Nov. 20, 2012

(51) Int. Cl. B23D 59/00; B23D 51/10; B23D 49/16

(52) U.S. Cl. CPC B23D 59/00; B23D 49/16; B23D 51/10
USPC 30/167; 30/329; 30/277.4

(57) ABSTRACT

An accessory for a reciprocating power tool including a first blade clamp mechanism and a linkage having a first end and a second end. The accessory further includes an attachment member coupled to the first blade clamp mechanism and to the first end of the linkage. The attachment member couples the linkage to the tool. A shaft is secured to the second end of the linkage and includes a second blade clamp mechanism. A distal member is coupled to the power tool and defines a channel through which the shaft extends. The channel defines a first stop surface and a second stop surface. A biasing mechanism is contained within the distal member and supported by one of the first and second stop surfaces. The biasing mechanism biases the shaft in a first position.

### BACKGROUND OF THE INVENTION

The present invention relates to accessories for power tools, and more particularly to an accessory for a reciprocating saw.

Reciprocating tools, such as reciprocating saws, typically include removable blades to allow for replacement of worn or damaged blades. Reciprocating tools also include removable accessories that accommodate a variety of working members. The accessories enable the reciprocating tools to be used for a numerous on various working surface and for a variety of types of projects

### SUMMARY OF THE INVENTION

In one construction, the invention provides an accessory for a reciprocating power tool including a first blade clamp mechanism. The accessory includes an attachment member received by the first blade clamp mechanism of the power tool. The accessory also includes a conduit, a collar, and a shaft. The conduit has a first end and a second end and defining a first channel therebetween. The collar defines a second channel and is coupled to the second end of the conduit such that the first and second channels are collinear. The shaft, which includes a second blade clamp mechanism, is received by the first and second channels and extends through the aperture in the conduit. As such, the shaft is slideable within and relative to the conduit and collar. A rim is coupled to the shaft and disposed within the first channel and a biasing mechanism is disposed within the first channel between the rim and the collar. A linkage extends between the shaft and the attachment member.

In another construction, the invention provides a reciprocating power tool including a housing supporting a motor that is actuatable by a trigger. The tool includes a spindle coupled to the motor wherein the motor reciprocatingly drives the spindle. The spindle includes a first blade clamp mechanism coupled to a distal end thereof. The tool includes an accessory member including an attachment member, which couples the linkage to the tool, coupled to the first blade clamp mechanism and to the first end of the linkage. A shaft is secured to the second end of the linkage and includes a second blade clamp mechanism. A distal member is coupled to the power tool and defines a channel through which the shaft extends. The channel defines a first stop surface and a second stop surface. A biasing mechanism is contained within the distal member and supported by one of the first and second stop surfaces. The biasing mechanism biases the shaft in a first position.

In another construction, the invention provides an accessory for a reciprocating power tool including a first blade clamp mechanism and a linkage having a first end and a second end. An attachment member, which couples the linkage to the tool, is coupled to the first blade clamp mechanism and to the first end of the linkage. A shaft is secured to the second end of the linkage and includes a second blade clamp mechanism. A distal member is coupled to the power tool and defines a channel through which the shaft extends. The channel defines a first stop surface and a second stop surface. A biasing mechanism is contained within the distal member and supported by one of the first and second stop surfaces. The biasing mechanism biases the shaft in a first position.

Other aspects of the invention will become apparent by consideration of the detailed description and accompanying drawings.

### BRIEF DESCRIPTION OF THE DRAWINGS

FIG. 1 is a side view of a reciprocating power tool including a blade clamp for receiving an accessory according to one embodiment of the invention.

FIG. 2 is a side view of the reciprocating saw shown in FIG. 1 and including an accessory for receiving a working member on a distal end and shoe.

FIG. 3 is a side view of the accessory shown in FIG. 2.

FIG. 4 is a perspective view of the accessory shown in FIG. 2.

FIG. 5 is a perspective view of the distal end of the accessory shown in FIG. 2.

FIG. 6 is a side view of the accessory of FIG. 2 having the shoe removed with the accessory in a first position.

FIG. 7 is a side view of the accessory of FIG. 2 having the shoe removed with the accessory in a second position.

FIG. 8 is a side view of the reciprocating power tool of FIG. 2 including a saw blade attached to the distal end of the accessory.

FIG. 9 is a side view of the reciprocating power tool of FIG. 2 including a chisel attached to the distal end of the accessory.

Before any constructions of the invention are explained in detail, it is to be understood that the invention is not limited in its application to the details of construction and the arrangement of components set forth in the following description or illustrated in the following drawings. The invention is capable of other constructions and of being practiced or of being carried out in various ways.

### DETAILED DESCRIPTION

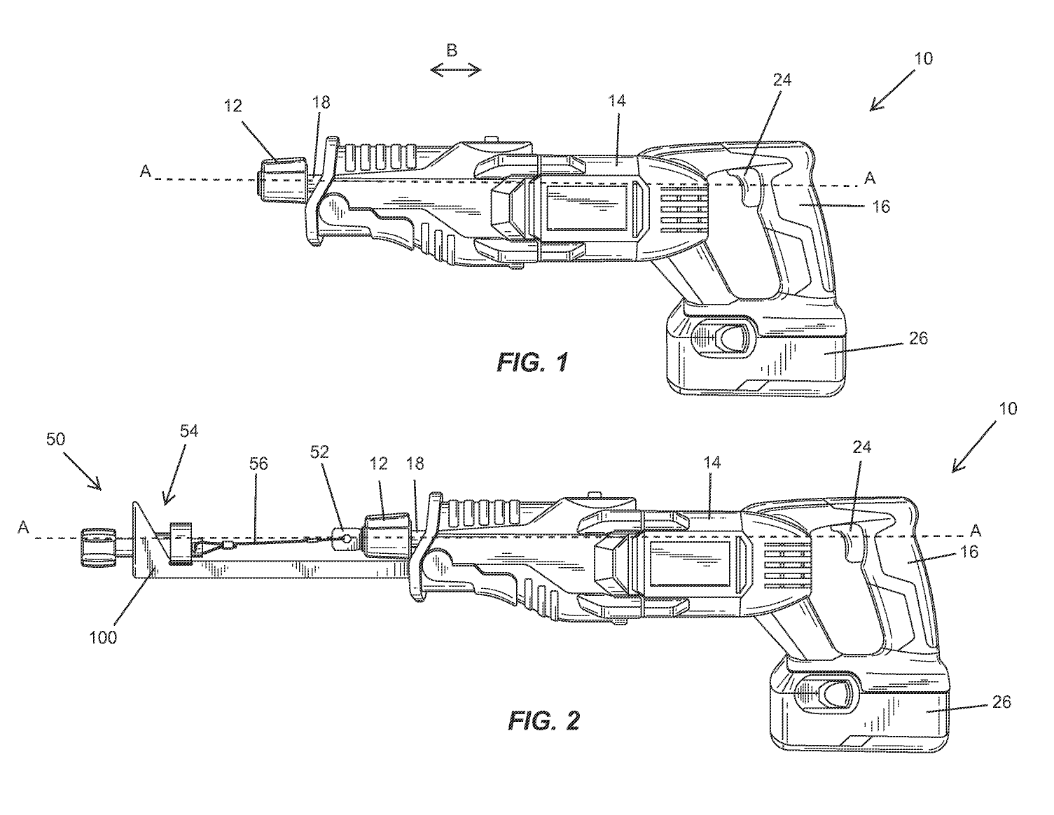

FIG. 1 illustrates a power tool 10 including a housing 14 having a handle portion 16, a motor (not shown) positioned within the housing 14, and a spindle 18 operatively coupled to the motor. A power tool 10 drive mechanism (not shown) positioned substantially within the housing 14 is coupled to the motor transferring rotational motion of a shaft of the motor into reciprocating motion of the spindle 18 along a longitudinal axis A relative to the housing 14. A blade clamp mechanism 12 is disposed at a distal end of the spindle 18 for receiving a saw blade (not shown) or accessory 50. The blade clamp mechanism 12 secures the blade or accessory 50 to the spindle 18 for reciprocation with the spindle 18 in a direction B, which is substantially parallel to the longitudinal axis A. In other embodiments, other suitable types and configurations of blade clamp mechanisms may be employed.

With continued reference to FIG. 1, the power tool 10 includes a trigger-type power switch or trigger 24 for activating a power supply 26 of the tool 10. In the illustrated embodiment, the power supply 26 is a rechargeable battery pack. The battery pack 26 is releasably coupled to the handle portion 16 to provide power to the power tool 10, and is releasable away from and forward of the handle portion 16. In the illustrated embodiment, the battery pack 26 is an eighteen-volt (18V) rechargeable power tool battery pack. In other embodiments, the battery pack 26 may be a twelve-volt (12V), a twenty-four-volt (24V), or other various voltages. According to another embodiment, the power supply 26 may be an alternating current (AC) power provided via a corded plug electrically coupled to a wall outlet or any number of suitable powering options.

In other embodiments, the power tool 10 may include various handle constructions, drive mechanisms, blade clamp mechanisms, and power configurations. In further embodiments, the power tool 10 may include other types of power and speed control switches or may not include a speed control feature.

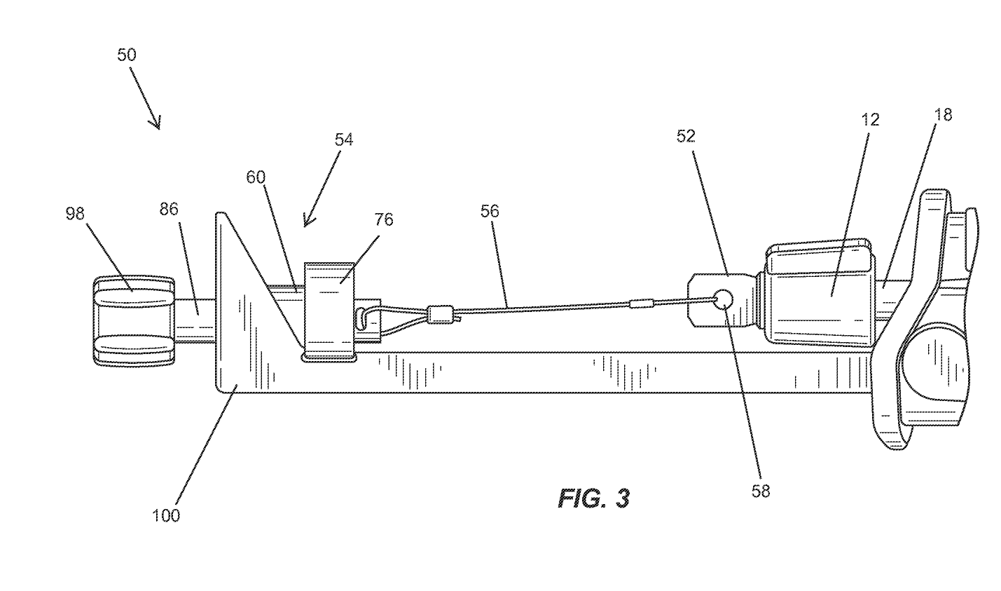

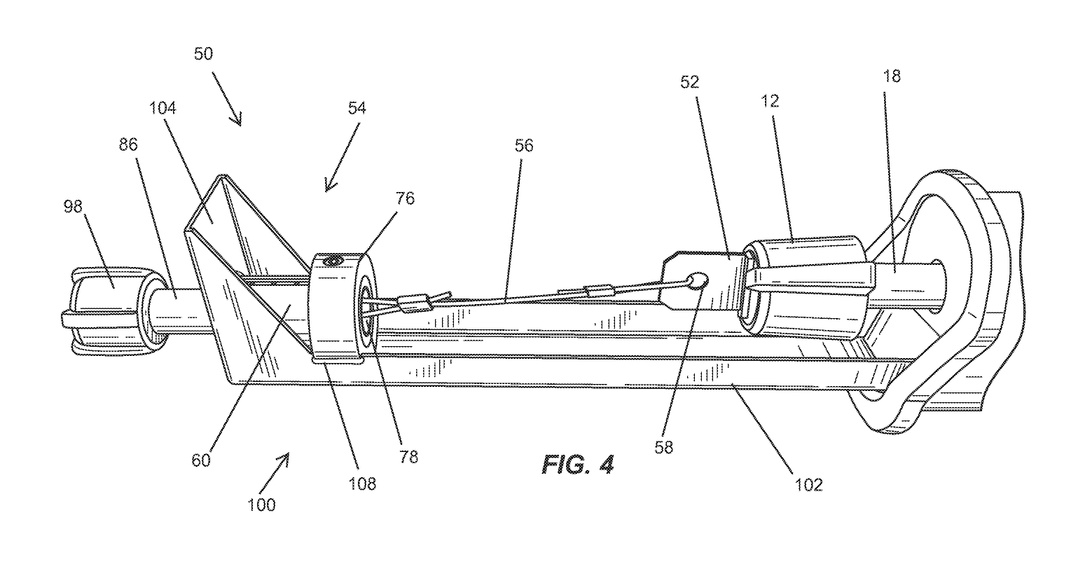

FIGS. 2-7 illustrate the accessory 50 according to one embodiment of the invention. The accessory includes an attachment member 52 and a distal member 54, whereby the attachment member 52 and the distal member 52 are coupled by an elongate linkage 56 therebetween. The elongate linkage 56 may be any rigid or semi-rigid structure that does not easily stretch or compress such as, for example, a cable, a chain, or the like. The linkage may have any suitable length. The attachment member 52 includes a tang (not shown) and a first aperture (not shown), which are configured to engage with the blade clamp mechanism 12 to securely and releasably connect the accessory 50 to the reciprocating tool 10. In other embodiments, other types or configurations of attachment members may be employed in order to suit the blade clamp mechanism 12 of the reciprocating tool 10. The attachment member 52 also includes a second aperture 58 that receives and secures a proximal end of the linkage 56.

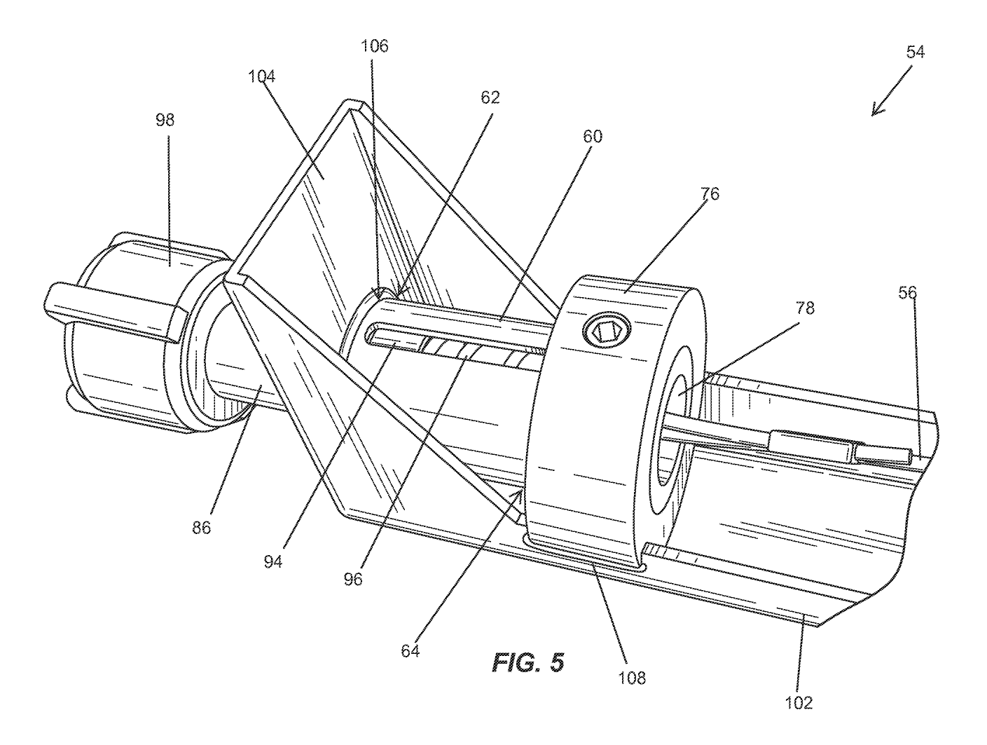

Further with respect to FIGS. 2-7, the distal member 54 includes a conduit 60 having a first end 62 and a second end 64. The conduit 60 has a first, outer diameter 66 and a second, inner diameter 68. The conduit 60 defines a chamber or channel 70 between the first and second ends 62, 64. The first end 64 of the conduit includes a through-hole 71 having a third diameter 72. A surface between the second diameter 68 and the third diameter 72 at the first end 62 of the conduit 60 defines a first stop surface 74. The second end 64 of the conduit 60 is coupled to a collar 76. The collar 76 defines a channel 78 (FIG. 5) therethrough having a diameter 80 that is substantially equal to the diameter 72 of through-hole 71 of the conduit 60. As such, the through-holes 70, 78 are aligned and collinear. The collar 76 has an outer diameter 82 that is greater than the outer diameter 66 of conduit 60. A surface between the diameter 80 of the through-hole 78 and second, inner diameter 68 at the second end 64 of the conduit 60 defines a second stop surface 84.

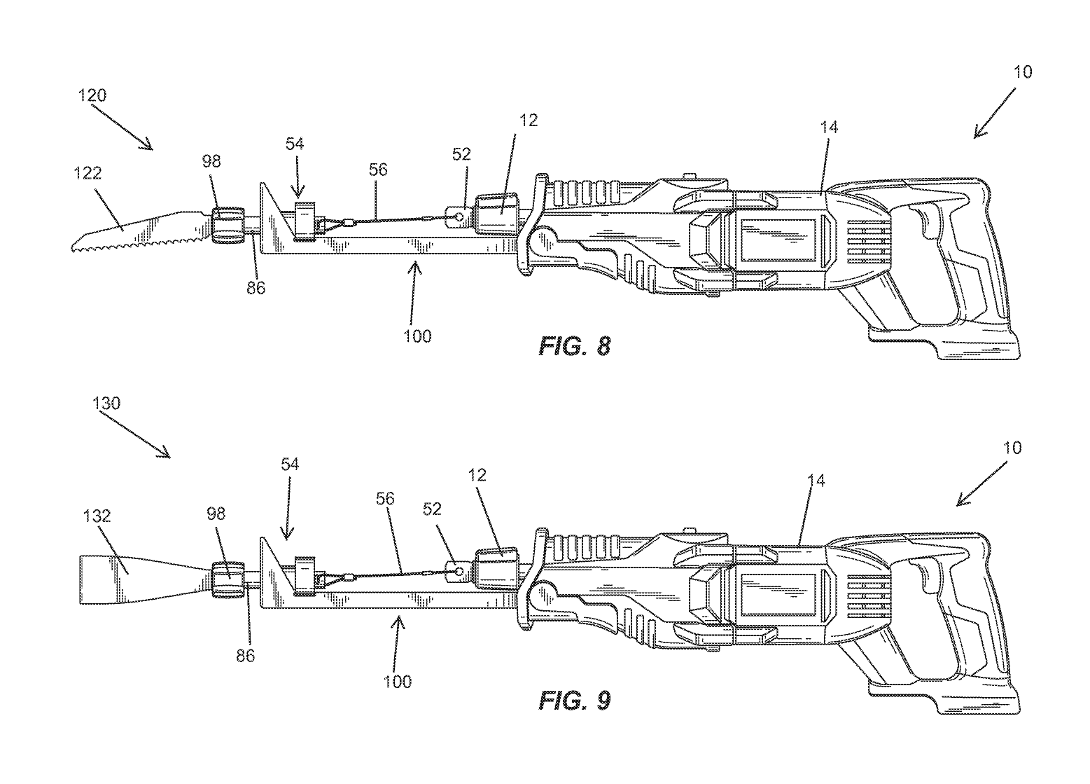

A shaft 86 having a first end 88 and a second end 90 extends through the through-holes 71, 78 of the conduit 60 and the collar 76. The first end 88 of the shaft 86 includes a blade clamp mechanism 98 that couples a working member 122, 132 (FIGS. 8-9) to the accessory 50. The second end 90 of the shaft 86 includes an aperture 92 that receives and secures a distal end of the linkage 56. The shaft 86 is sized to be slidable within the through-holes 71, 78 of the conduit 60 and the collar 76. A rim or lip 94 is coupled to the shaft 86. The rim 94 is sized to be slidable within the channel 70 of the conduit 60 between the first and second stop surfaces 74, 84, and has a diameter greater than the through-hole 71 of the conduit 60. A biasing mechanism or spring 96 is disposed between the rim 94 and the collar 76 within the conduit 60.

The power tool 10 also includes a removable shoe 100, illustrated in FIGS. 2-5 and 8-9, operable to engage a work piece and provide stability to the tool 10 while in use. The shoe 100 may be removed when the accessory 50 is attached to the blade clamp mechanism 12. The shoe 100 supports the accessory 50 relative to the tool housing 14. In the illustrated embodiment, the shoe includes an elongate post 102 having a distal abutment surface 104. An aperture 106 in the abutment surface 104 slidably receives the shaft 86 such that the blade clamp mechanism 98 is disposed in front of the abutment surface 104. The elongate post 102 also includes at least one recess 108 for receiving and securing the collar 76 therein. As such the collar 76, and therefore the conduit 60, is secured relative to the shoe 100 and also the power tool 10. In the illustrated embodiment, the abutment surface 104 is not moveable with respect to the post 102. Further embodiments may accommodate an abutment surface that is adjustable relative to the post 102 of the shoe 100.

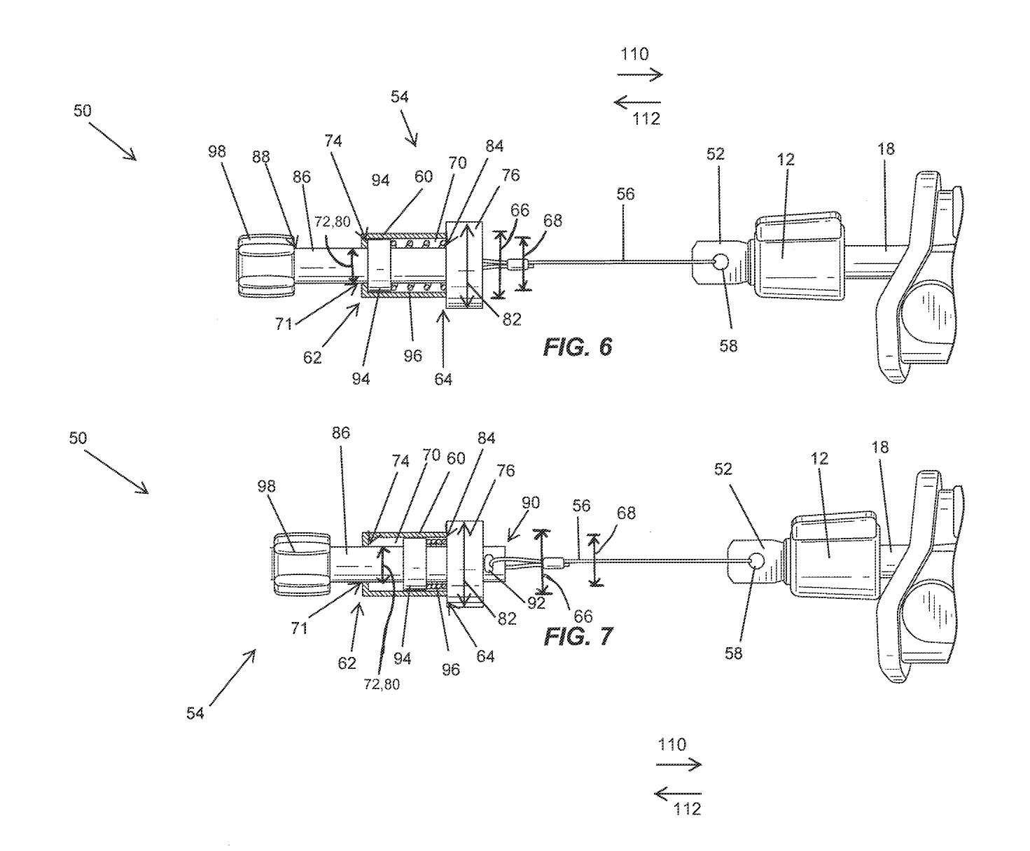

In operation, the accessory shaft 86 is reciprocated within the through-holes 71, 78 of the conduit 60 and collar 76 between a first position (FIG. 6) and a second position (FIG. 7) such that the rim 94 reciprocates between the first and second stop surfaces 74, 84 of the distal member 54. The blade clamp mechanisms 12, 98, the linkage 56, and the shaft 86 move in unison between the first and second positions in response to reciprocating motion of the spindle 18. In the first position, the bias of the spring 96 forces the rim 94 to abut the first stop surface 74. When in the first position, there is a maximum distance between the working member 122, 132 and the tool housing 14. When actuated by the trigger 24, the reciprocating motion of the spindle 18 pulls on the linkage 56 in the direction of arrow 110 against the bias of the spring 96 and into the second position. In the second position, the spring 96 is compressed between the rim 94 and the second stop surface 84. When in the second position, there is a minimum distance between the working member 122, 132 and the tool housing 14. When reciprocating motion of the spindle 18 moves forward, the spring 96 exerts a force on the rim 94 thereby launching the shaft 86 in the direction of arrow 112. A small spring (not shown) may be included between the rim 94 and the first stop surface 74. The small spring prevents the linkage 56 from having to take the entire force required to change the direction of mass each time the spindle 18 pulls on the linkage 56. The reciprocating motion of the spindle 18 is only responsible for pulling the working member 122, 132 in the direction of arrow 110. Forward motion in the direction of arrow 112 results from the bias of the spring 96 against the rim 94 of the distal member 54.

FIGS. 8-9 illustrate the accessory 50 used as an extension accessory 120 or a jackhammer accessory 130. When used as an extension accessory 120 (FIG. 8), the blade clamp mechanism 98 coupled to the shaft 86 secures a blade 122 to the accessory 50. The blade 122 may be used to cut work pieces that are difficult to reach. For example, the extension accessory 120 is ideal for cutting, among other things, tree limbs or holes in ceilings or cabinets. The accessory 120 extends the length of the power tool 10. The use of a linkage 56 to secure the distal member 54 to the attachment member 52 ensures that the weight of the extension accessory 120 is light enough to achieve reciprocating motion. Additionally, the linkage 56 keeps the weight of the tool 10 (i.e., housing 14, battery 26, etc.) in the user's hand, thereby allowing better control of the tool 10.

When used as a jackhammer accessory 130 (FIG. 9), the blade clamp mechanism 98 coupled to the shaft 86 secures a chisel 132 to the accessory 50. As such, when the shaft 86 carrying the chisel 132 is launched in the direction of arrow the 112, the chisel 132 impacts a work piece to break down the surface thereof. Because the reciprocating motion of spindle 18 is only responsible or pulling the chisel (in the direction of arrow 110), the reciprocating mechanism is protected against damage that results when the chisel slams into the work piece.

Thus, constructions of the invention provide, among other things, a power tool including an accessory that uses a linkage to couple a distal member to an attachment member thereby extending the length of the power tool. The linkage accommodates a greater length of the tool without adding significant additional weight to the distal end thereby giving the user more control because weight in the user's hand. Additionally, because the accessory uses a spring to launch the shaft the reciprocating mechanism is only responsible for pulling the accessory toward the power tool thereby protecting the reciprocating mechanism from being damaged during forward motion of the distal member.

Various features of the invention are set forth in the following claims.

What is claimed is:

1. An accessory for a reciprocating power tool including a first blade clamp mechanism, the accessory comprising:
an attachment member received by the first blade clamp mechanism of the power tool;
a conduit having a first end and a second end and defining a first channel therebetween;
a collar defining a second channel and coupled to the second end of the conduit such that the first and second channels are collinear;
a shaft including a second blade clamp mechanism, the shaft received by the first and second channels and extending through the aperture in the conduit such that the shaft is slideable within and relative to the conduit and collar;
a rim coupled to the shaft and disposed within the first channel;
a biasing mechanism disposed within the first channel between the rim and the collar; and
a linkage extending between the shaft and the attachment member.

2. The accessory of claim 1, wherein the shaft is moveable between a first position and a second position.

3. The accessory of claim 2, wherein in the first position the biasing mechanism biases the shaft such that the rim abuts the second end of the conduit.

4. The accessory of claim 2, wherein in the second position the shaft overcomes the bias of the biasing mechanism such that the rim compresses the biasing mechanism against the collar.

5. The accessory tool of claim 2, wherein the shaft is moved from the first position to the second position against the bias of the biasing mechanism upon actuation of a motor of the power tool and wherein the bias of the biasing mechanism launches the shaft from the second position to the first position.

6. The accessory of claim 2, wherein the first blade clamp mechanism, the second blade clamp mechanism, the linkage, and the shaft move in unison between the first and second positions.

7. The accessory of claim 1 further comprising one of a chisel or a blade received by the second blade clamp.

8. A reciprocating power tool comprising:
a housing supporting a motor, the motor actuatable by a trigger;
a spindle coupled to the motor wherein the motor reciprocatingly drives the spindle, the spindle including a first blade clamp mechanism coupled to a distal end thereof;
an accessory member comprising:
a linkage having a first end and a second end;
an attachment member coupled to the first blade clamp mechanism and to the first end of the linkage, wherein the attachment member couples the linkage to the power tool;
a shaft secured to the second end of the linkage, the shaft including a second blade clamp mechanism;
a distal member coupled to the power tool and defining a channel through which the shaft extends, the channel defining a first stop surface and a second stop surface; and
a biasing mechanism contained within the distal member and supported by one of the first and second stop surfaces, the biasing mechanism biases the shaft to a first position.

9. The accessory of claim 8, wherein the shaft includes a rim contained within the channel, the shaft being slidable relative to the distal member such that the shaft reciprocates between the first position and a second position.

10. The accessory of claim 9, wherein when the shaft is in the first position, the biasing mechanism biases the shaft such that the rim abuts the first stop surface.

11. The accessory of claim 9, wherein when the shaft is in the second position, the shaft overcomes the bias of the biasing mechanism such that the rim compresses the biasing mechanism against the second stop surface.

12. The accessory of claim 9, wherein the shaft is moved from the first position to the second position against the bias of the biasing mechanism upon actuation of the motor and wherein the bias of the biasing mechanism launches the shaft from the second position to the first position.

13. The reciprocating power tool of claim 9, wherein the first blade clamp mechanism, the second blade clamp mechanism, the linkage, and the shaft move in unison between the first and second positions.

14. The reciprocating power tool of claim 8 further comprising one of a blade or a chisel received by the second blade clamp mechanism.

15. The accessory of claim 8 further comprising a removable shoe including an elongate post received within the housing and an abutment surface, wherein the abutment surface includes an aperture that receives the shaft.

16. The accessory of claim 15, wherein the post secures the distal member relative to the power tool.

17. An accessory for a reciprocating power tool including a first blade clamp mechanism, the accessory comprising:
a linkage having a first end and a second end;
an attachment member coupled to the first blade clamp mechanism and to the first end of the linkage, wherein the attachment member couples the linkage to the tool;
a shaft secured to the second end of the linkage, the shaft including a second blade clamp mechanism;
a distal member coupled to the power tool and defining a channel through which the shaft extends, the channel defining a first stop surface and a second stop surface; and
a biasing mechanism contained within the distal member and supported by one of the first and second stop surfaces, the biasing mechanism biases the shaft to a first position.

18. The accessory of claim 17, wherein the shaft includes a rim contained within the channel, the shaft being slidable relative to the distal member such that the shaft reciprocates between the first position and a second position.

19. The accessory of claim 18, wherein when the shaft is in the first position, the biasing mechanism biases the shaft such that the rim abuts the first stop surface.

20. The accessory of claim 18, wherein when the shaft is in the second position, the shaft overcomes the bias of the biasing mechanism such that the rim compresses the biasing mechanism against the second stop surface.

21. The accessory tool of claim 18, wherein the shaft is moved from the first position to the second position against the bias of the biasing mechanism upon actuation of a motor of the power tool and wherein the bias of the biasing mechanism launches the shaft from the second position to the first position.

22. The accessory tool of claim 18, wherein the first blade clamp mechanism, the second blade clamp mechanism, the linkage, and the shaft move in unison between the first and second positions.

23. The accessory of claim 17 further comprising one of a blade or a chisel received by the second blade clamp mechanism.
